(19) United States
(12) Patent Application Publication
(10) Pub. No.: US 2026/0172153 A1
(43) Pub. Date: Jun. 18, 2026

(54) UPLINK DELAYED RELIABLE ACKNOWLEDGMENT CODEBOOK TRANSMISSION

(71) Applicant: QUALCOMM Incorporated, San Diego, CA (US)

(72) Inventors: Morteza SOLTANI, San Diego, CA (US); Jing SUN, San Diego, CA (US); Mostafa KHOSHNEVISAN, San Diego, CA (US)

(21) Appl. No.: 18/978,396

(22) Filed: Dec. 12, 2024

(51) Int. Cl. H04L 1/1867; H04W 72/1268; H04W 76/38

(52) U.S. Cl. CPC H04L 1/1896; H04W 72/1268; H04W 76/38

(57) ABSTRACT

Various aspects of the present disclosure generally relate to wireless communication. In some aspects, a user equipment (UE) may transmit, to a network node, a first message comprising hybrid automatic repeat request (HARQ) feedback associated with a transport block. The UE may initiate a timer based at least in part on transmitting the first message. The UE may transmit a second message that includes additional feedback associated with the first message prior to an expiration of the timer. In some aspects, the UE may transmit, to a network node, a first message comprising HARQ feedback associated with a transport block. The UE may receive, from the network node, a second message that includes additional feedback associated with the first message. Numerous other aspects are described.

### FIELD OF THE DISCLOSURE

Aspects of the present disclosure generally relate to wireless communication and specifically relate to techniques, apparatuses, and methods associated with uplink delayed reliable acknowledgement codebook transmission.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

In some wireless communication systems, a user device (UE) may be configured to perform communications with one or more network nodes. For example, the UE may receive one or more transport blocks (TBs) from a network node, which may carry data (e.g., voice, text, video, or other traffic) to the UE. In some cases, the UE may be configured to transmit feedback messages after receiving a transport block, such as a hybrid automatic repeat request (HARQ) feedback message. For example, the UE may transmit a positive acknowledgment (ACK) based on successfully decoding a TB, or the UE may transmit a negative acknowledgment (NACK) if decoding was not successful. In some examples, the network node may perform a retransmission of a transport block based on receiving a NACK, which may improve the reliability of communications with the UE.

### SUMMARY

Some aspects described herein relate to a user equipment (UE) for wireless communication. The UE may include one or more memories and one or more processors coupled to the one or more memories. The one or more processors may be configured to transmit, to a network node, a first message comprising hybrid automatic repeat request (HARQ) feedback associated with a transport block (TB). The one or more processors may be configured to initiate a timer based at least in part on transmitting the first message. The one or more processors may be configured to transmit a second message that includes additional feedback associated with the first message prior to an expiration of the timer.

Some aspects described herein relate to a method of wireless communication performed by a UE. The method may include transmitting, to a network node, a first message comprising HARQ feedback associated with a TB. The method may include initiating a timer based at least in part on transmitting the first message. The method may include transmitting a second message that includes additional feedback associated with the first message prior to an expiration of the timer.

Some aspects described herein relate to a non-transitory computer-readable medium that stores a set of instructions for wireless communication by a UE. The set of instructions, when executed by one or more processors of the UE, may cause the UE to transmit, to a network node, a first message comprising HARQ feedback associated with a TB. The set of instructions, when executed by one or more processors of the UE, may cause the UE to initiate a timer based at least in part on transmitting the first message. The set of instructions, when executed by one or more processors of the UE, may cause the UE to transmit a second message that includes additional feedback associated with the first message prior to an expiration of the timer.

Some aspects described herein relate to an apparatus for wireless communication. The apparatus may include means for transmitting, to a network node, a first message comprising HARQ feedback associated with a TB. The apparatus may include means for initiating a timer based at least in part on transmitting the first message. The apparatus may include means for transmitting a second message that includes additional feedback associated with the first message prior to an expiration of the timer.

Some aspects described herein relate to a network node for wireless communication. The network node may include one or more memories and one or more processors coupled to the one or more memories. The one or more processors may be configured to receive, from a UE, a first message comprising HARQ feedback associated with a TB. The one or more processors may be configured to initiate a timer based at least in part on receiving the first message. The one or more processors may be configured to receive a second message that includes additional feedback associated with the first message prior to an expiration of the timer.

Some aspects described herein relate to a method of wireless communication performed by a network node. The method may include receiving, from a UE, a first message comprising HARQ feedback associated with a TB. The method may include initiating a timer based at least in part on receiving the first message. The method may include receiving a second message that includes additional feedback associated with the first message prior to an expiration of the timer.

Some aspects described herein relate to a non-transitory computer-readable medium that stores a set of instructions for wireless communication by a network node. The set of instructions, when executed by one or more processors of the network node, may cause the network node to receive, from a UE, a first message comprising HARQ feedback associated with a TB. The set of instructions, when executed by one or more processors of the network node, may cause the network node to initiate a timer based at least in part on receiving the first message. The set of instructions, when executed by one or more processors of the network node, may cause the network node to receive a second message that includes additional feedback associated with the first message prior to an expiration of the timer.

Some aspects described herein relate to an apparatus for wireless communication. The apparatus may include means for receiving, from a UE, a first message comprising HARQ feedback associated with a TB. The apparatus may include means for initiating a timer based at least in part on receiving the first message. The apparatus may include means for receiving a second message that includes additional feedback associated with the first message prior to an expiration of the timer.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a hybrid automatic repeat request (HARQ) process, in accordance with the present disclosure.

FIGS. 4A and 4B are diagrams illustrating examples of uplink delayed reliable acknowledgement codebook transmission, in accordance with the present disclosure.

FIGS. 5A and 5B are diagrams illustrating examples of uplink delayed reliable acknowledgement codebook transmission, in accordance with the present disclosure.

FIG. 6 is a diagram illustrating an example of uplink delayed reliable acknowledgement codebook transmission, in accordance with the present disclosure.

FIG. 7 is a diagram illustrating an example of uplink delayed reliable acknowledgement codebook transmission, in accordance with the present disclosure.

FIG. 8 is a diagram illustrating an example process performed, for example, at a user equipment (UE) or an apparatus of a UE, in accordance with the present disclosure.

FIG. 9 is a diagram illustrating an example process performed, for example, at a network node or an apparatus of a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some telecommunication systems, a user device (UE) may be configured to perform communications with one or more network nodes. For example, the UE may receive one or more transport blocks (TBs) from a network node, and the one or more TBs may carry data (e.g., voice, text, video, or other traffic) to the UE. In some cases, the UE may be configured to transmit feedback messages to the network node after receiving a TB or after not receiving a message for a scheduled transport, such as a hybrid automatic repeat request (HARQ) feedback message. For example, the UE may transmit a positive acknowledgment (ACK) based on successfully decoding a TB, or the UE may transmit a negative acknowledgment (NACK) if decoding of the TB was not successful or the TB was not received. In some examples, the network node may perform a retransmission of a TB based on receiving a NACK, which may improve the reliability of communications with the UE.

In some cases, however, transmission of the HARQ feedback message may be unreliable, which may result in errors in transmission of one or more TBs. For instance, the UE may transmit a feedback message including a NACK to request retransmission of a TB, but the network node may interpret (e.g., decode, receive) the feedback message as an ACK and may not perform the retransmission (e.g., a NACK-to-ACK (N2A) error). In some other examples, a discontinuous transmission from the UE may be interpreted by the network node as an ACK, such as in cases when downlink control information (DCI) scheduling a transmission of the TB was not received (e.g., successfully) by the UE. In these examples, the UE may not have received or decoded the TB successfully, but the network node may not have received a NACK from the UE as the UE may not be aware that the TB transmission was scheduled due to the missed DCI, and the network node may not perform the retransmission of the TB.

In some cases, the reliability of the HARQ feedback message may be improved by using N2A error detection techniques, in which the UE or the network node may attempt to detect cases in which a NACK was not received successfully by the network node. Additionally, or alternatively, the reliability of the HARQ feedback message may be improved by using missing DCI detection techniques, such as by using a new data indicator (NDI) and HARQ identifier for new TB transmissions. However, these approaches may increase complexity for the UE or the network node associated with detecting the error conditions, and may lead to increased overhead and power consumption for the UE and/or the network node.

Various aspects relate generally to transmission of a reliable feedback message (e.g., a reliable ACK/NACK (R-A/N)) that follows a HARQ feedback message transmitted by a UE. Some aspects more specifically relate to using a timer associated with transmitting the HARQ feedback message for transmission of the reliable feedback message by the UE or a network node. For example, the reliable feedback message may repeat feedback indicated by the HARQ feedback message, such as an ACK or a NACK. In some aspects, the reliable feedback message may be transmitted by the UE by multiplexing the reliable feedback message with a payload of an uplink data transmission. In some examples, the UE may request a resource for an uplink data transmission to transmit the reliable feedback message, or the UE may transmit the reliable feedback message using a connectionless uplink (CLUL) resource. In some aspects, the UE may transmit the reliable feedback message in accordance with an expiration of a timer. In some examples, the timer may be extended to align with a next (e.g., upcoming) scheduling request (SR) resource or a CLUL resource and/or based on a processing timeline for transmission of the SR or preparation of an uplink message containing the reliable feedback message. In some aspects, the UE may be configured to multiplex the reliable feedback message to multiple uplink messages, which may improve the reliability of the transmission. In some examples, the network node may be configured to transmit an acknowledgment message corresponding to the reliable feedback message, and the UE may perform a retransmission of the reliable feedback message if the acknowledgment from the network node is not received.

Additionally, or alternatively, the network node may transmit a downlink message including the reliable feedback message based on receiving the HARQ feedback message from the UE. In some examples, the reliable feedback message may include information to associate the reliable feedback message with a HARQ feedback message previously transmitted by the UE, such as a slot index associated with the HARQ feedback transmission. In some aspects, the UE may transmit an indication of a mismatch between the reliable feedback message and the HARQ message based on receiving the reliable feedback message. For example, if the HARQ feedback included a NACK, and the reliable feedback message indicated an ACK, the UE may transmit the indication of the mismatch, and the network node may perform a retransmission of the TB. In some aspects, to support performing the comparison, the UE may be configured to store an indication of the HARQ feedback, for example, during a duration of a timer initiated based on transmission of the HARQ feedback. Additionally, or alternatively, the network node may initiate a timer based on transmission of the reliable feedback message to await the indication of the mismatch from the UE, and the network node may clear a buffer associated with the TB after expiration of the timer. In some aspects, both uplink and downlink reliable feedback may be configured. For example, if the UE transmits uplink reliable feedback which is received by the network node, the network node may refrain from transmitting downlink reliable feedback. Additionally, or alternatively, if the network node transmits downlink reliable feedback which is received by the UE, the UE may refrain from transmitting uplink reliable feedback.

Particular aspects of the subject matter described in this disclosure can be implemented to realize one or more of the following potential advantages. In some examples, by transmitting the reliable feedback message following the HARQ feedback message, errors in the reception of the HARQ feedback message may be reduced, and retransmissions of a corresponding TB may be transmitted by the network node if requested by the UE. In some aspects, by transmitting the reliable feedback message after a duration (e.g., in accordance with a timer), the reliable feedback message may be transmitted along with an uplink message and with a more flexible timeline, which may improve the reliability of feedback associated with TBs. Additionally, the described techniques relating to transmission of the reliable feedback message may be implemented with relatively low complexity, which may improve the reliability of the feedback without a large increase in processing overhead or device complexity for the UE or the network node. In some aspects, transmission of a downlink reliable feedback message may allow for timely resolution of HARQ feedback in cases where there may be limited uplink traffic for the UE to multiplex and/or transmit uplink reliable feedback, or in cases where a downlink/uplink budget imbalance exists which favors downlink resources. Additionally, or alternatively, the use of downlink reliable feedback may achieve the improved reliability of HARQ feedback resolution while reducing the impact on UE overhead or power consumption.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

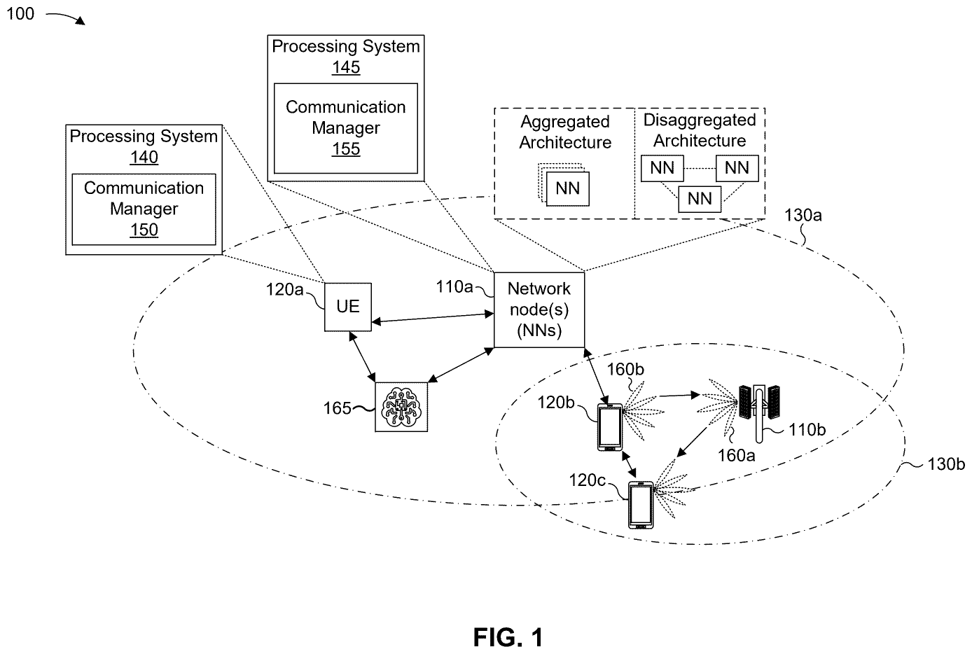

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

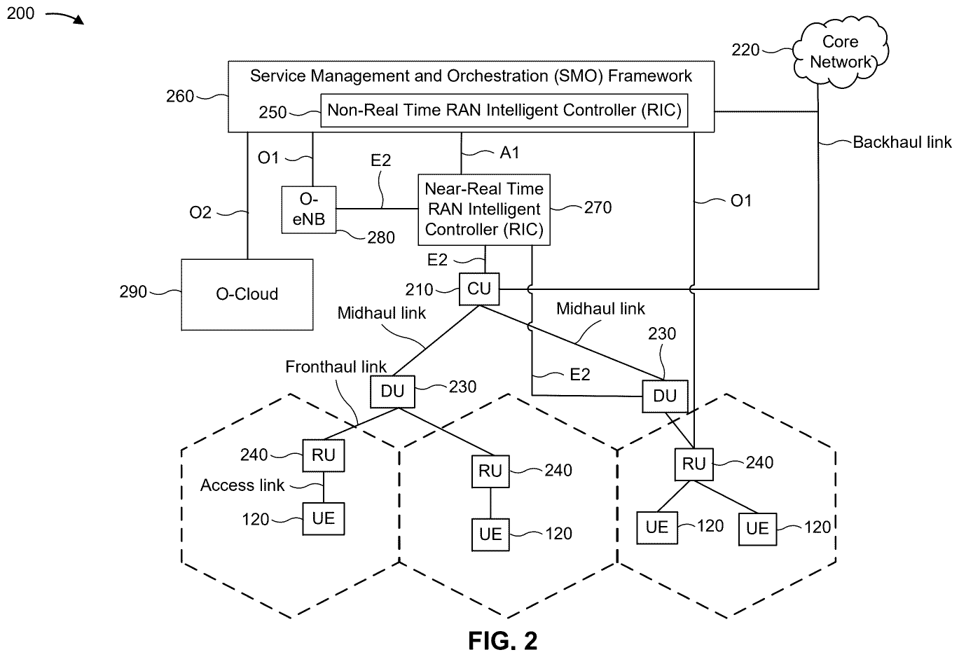

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100 and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, HARQ information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more TBs of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include an SR, HARQ feedback information (for example, a HARQ ACK indication or a HARQ NACK indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, the UE 120 may include a communication manager 150. As described in more detail elsewhere herein, the communication manager 150 may transmit, to a network node, a first message comprising HARQ feedback associated with a TB; initiate a timer based at least in part on transmitting the first message; and transmit a second message that includes additional feedback associated with the first message prior to an expiration of the timer. Additionally, or alternatively, the communication manager 150 may perform one or more other operations described herein.

In some aspects, the network node 110 may include a communication manager 155. As described in more detail elsewhere herein, the communication manager 155 may receive, from a UE, a first message comprising HARQ feedback associated with a TB; initiate a timer based at least in part on receiving the first message; and receive a second message that includes additional feedback associated with the first message prior to an expiration of the timer. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

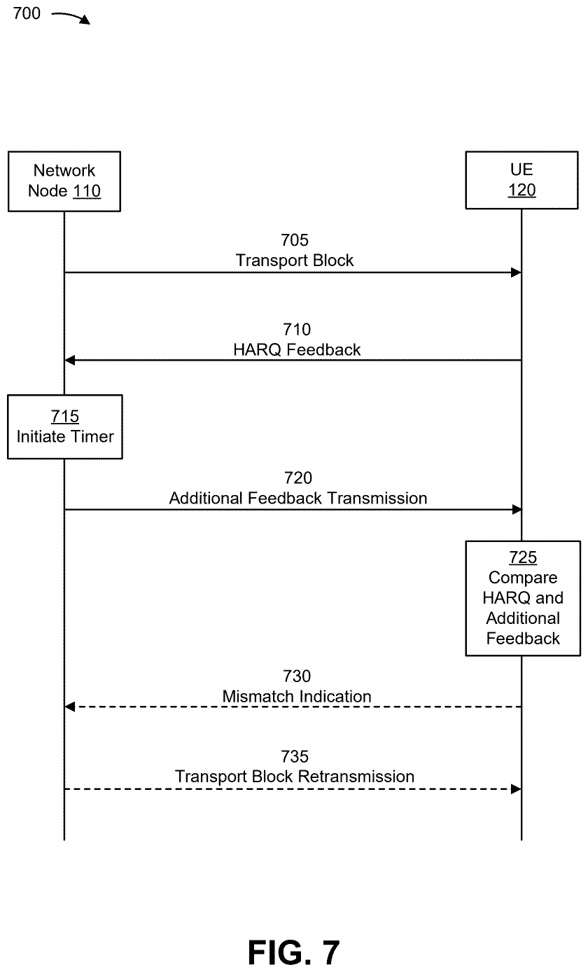

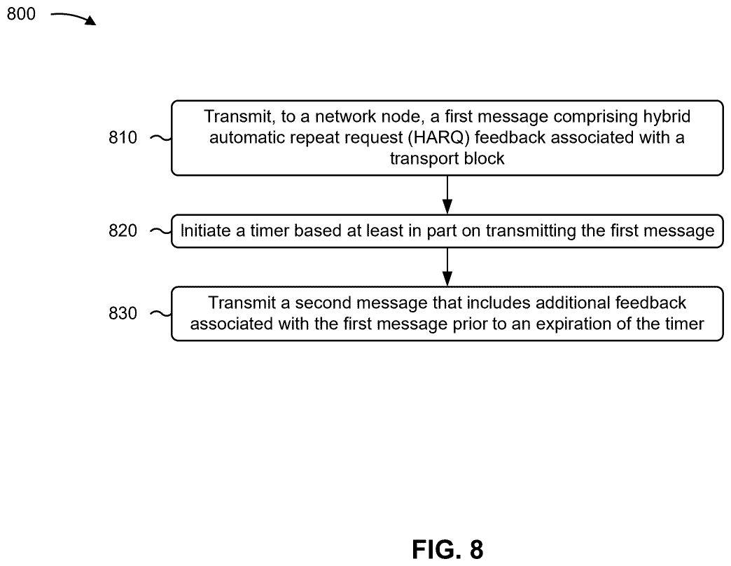

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with uplink delayed reliable acknowledgement codebook transmission, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

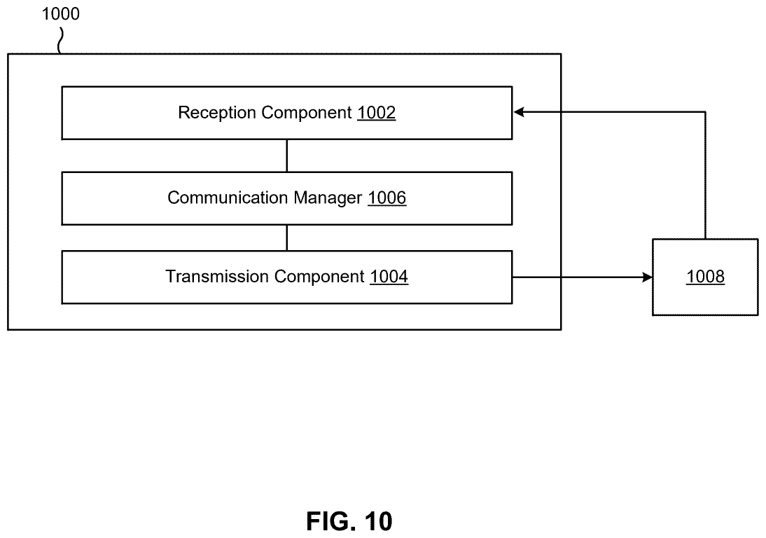

In some aspects, the UE 120 includes means for transmitting, to a network node 110, a first message comprising HARQ feedback associated with a TB; means for initiating a timer based at least in part on transmitting the first message; and/or means for transmitting a second message that includes additional feedback associated with the first message prior to an expiration of the timer. The means for the UE 120 to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10, and/or a transmission component (for example, transmission component 1004 depicted and described in connection with FIG. 10), among other examples.

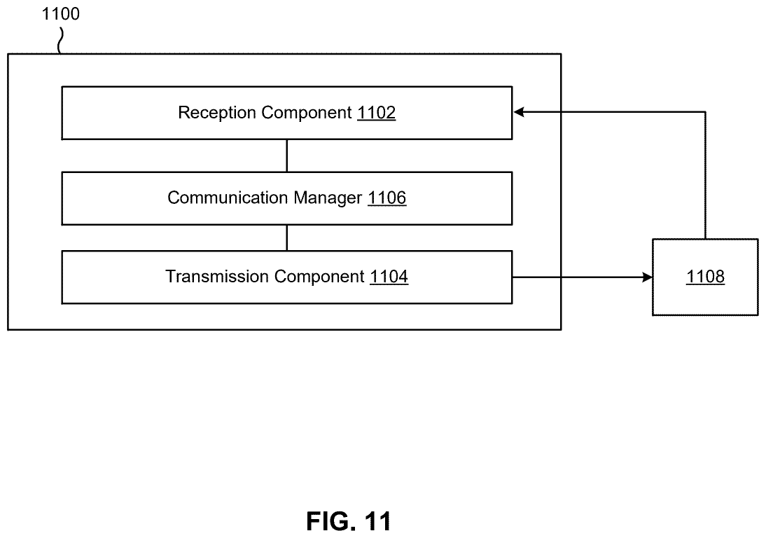

In some aspects, the network node 110 includes means for receiving, from a UE 120, a first message comprising HARQ feedback associated with a TB; means for initiating a timer based at least in part on receiving the first message; and/or means for receiving a second message that includes additional feedback associated with the first message prior to an expiration of the timer. The means for the network node 110 to perform operations described herein may include, for example, one or more of communication manager 155, processing system 145, a radio, one or more RF chains, one or more transceivers, one or more antennas, one or more modems, a reception component (for example, reception component 1102 depicted and described in connection with FIG. 11, and/or a transmission component (for example, transmission component 1104 depicted and described in connection with FIG. 11, among other examples.

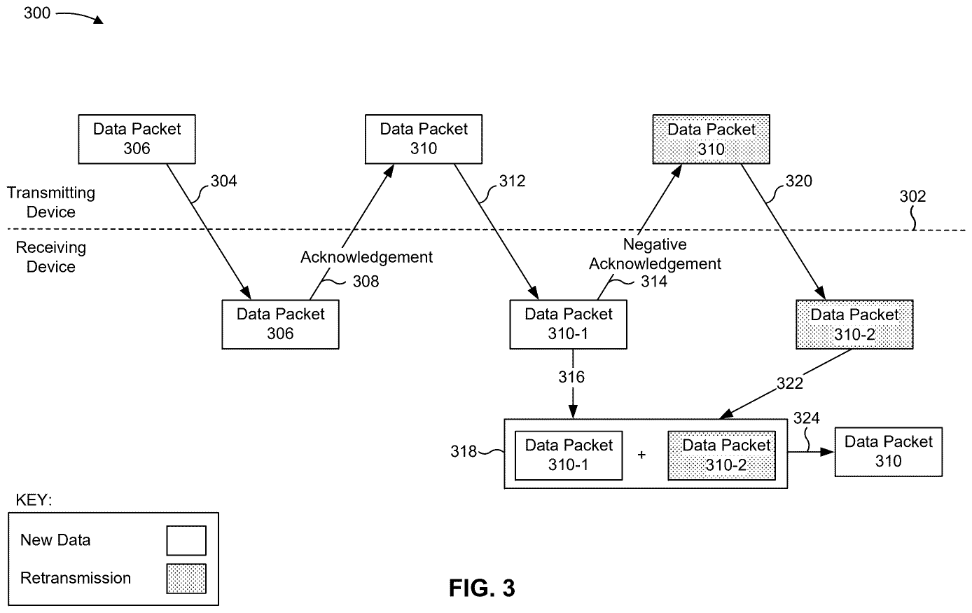

FIG. 3 is a diagram illustrating an example 300 of a HARQ process, in accordance with the present disclosure.

A MAC layer of a protocol stack may implement a HARQ protocol to provide a faster retransmission mechanism relative to other retransmission mechanisms, such as a radio link control (RLC) layer retransmission system. In some aspects, the HARQ protocol may include a transmitting device using a retransmission protocol in combination with a receiving device, such as a send and wait (SAW) protocol that enables the receiving device to recover and/or correct data errors in a first HARQ process without hindering data transmissions in a second HARQ process. Accordingly, multiple HARQ processes may operate in parallel, and data errors identified in the first HARQ process may not hinder transmissions in the second HARQ process. Some non-limiting examples of transmitting device/receiving device pairs that may implement a HARQ process in combination may include a network node 110 and a UE 120 (e.g., a downlink HARQ process), a UE 120 and a network node 110 (e.g., an uplink HARQ process), and/or a first UE 120 and a second UE 120 (e.g., a sidelink HARQ process). Thus, a HARQ process may be used for downlink communications, uplink communications, and/or sidelink communications. In some aspects, and as part of a HARQ process, a network node may transmit information in one or more DCI messages that indicates to a receiving device (e.g., a UE 120) which downlink transmission(s) and/or which uplink transmissions to process using a HARQ protocol. Alternatively, or additionally, and as part of the HARQ process, a first UE may transmit information in sidelink control information (SCI) that indicates, to a second UE, which sidelink transmission(s) to process using the HARQ protocol.

In some aspects, a HARQ process and/or HARQ protocol may enable a receiving device to correct errors in a received data packet, such as by correcting errors within a TB based at least in part on soft combining packets, as described below. In some aspects, a TB may be partitioned into one or more code block groups (CBGs), and each CBG may partitioned into one or more code blocks (CBs). To correct for errors, the receiving device may buffer one or more data packets that have been identified as including an error, combine the data packets, and process the combined data packets to reduce errors. In some aspects, “codeword” (CW) may refer to a TB that includes error protection, and a transmission may include multiple CWs.

The example 300 includes transactions between a transmitting device and a receiving device. Transactions and/or data located above dashed line 302 are performed by, and/or reside at, a transmitting device (e.g., a network node 110 for a downlink HARQ process, a UE 120 for an uplink HARQ process, and/or a first UE 120 for a sidelink HARQ process). Transactions and/or data located below the dashed line 302 are performed by, and/or reside at, a receiving device (e.g., a UE 120 for a downlink HARQ process, a network node 110 for an uplink HARQ process, and/or a second UE 120 for a sidelink HARQ process). As shown by reference number 304, the transmitting device may transmit a first data packet 306 that is a new transmission of data that is included in the first data packet 306 (e.g., a first transmission of the data, shown through the use of solid white). In some aspects, the transmitting device may buffer and/or store the first data packet 306 as part of a HARQ process until receiving an indication from the receiving device that the first data packet 306 has been received and/or recovered with minimal errors (e.g., error-free and/or a number of errors that satisfy a low threshold). Based at least in part on receiving the first data packet 306 with minimal errors, the receiving device may transmit an acknowledgement (ACK) to the transmitting device as shown by reference number 308, such as a HARQ acknowledgement. The receiving device may validate the first data packet 306 using any suitable error detection mechanism, such as a cyclic redundancy check (CRC) process that validates the received data by computing a CRC value using the received data and comparing the computed CRC value(s) to a CRC value included with the received data.

Based at least in part on receiving the ACK, the transmitting device may transmit a second data packet 310 as shown by reference number 312, and the second data packet 310 may be a new transmission of data (e.g., different data than the data included in the first data packet 306). In a similar manner as the first data packet 306, the transmitting device may store the second data packet 310 in the buffer and/or remove the first data packet 306 from the buffer. In some aspects, the receiving device may not receive the second data packet 310 (shown in FIG. 3 as data packet 310-1) successfully. For example, the receiving device may identify that the data packet 310-1 was received with a number of errors that fail to satisfy the low error threshold. Accordingly, and as shown by reference number 314, the receiving device may transmit a negative acknowledgement (NACK) to indicate that the second data packet 310 was received with errors and/or unsuccessfully. Alternatively, or additionally, the receiving device may transmit the NACK to indicate a request for a retransmission of the second data packet 310. In some aspects, and as shown by reference number 316, the receiving device may store the data packet 310-1 in a buffer 318.

Based at least in part on receiving the NACK, and as shown by reference number 320, the transmitting device may retransmit the second data packet 310 to the receiving device, where the retransmission is shown in FIG. 3 through the use of a dotted pattern. The receiving device may receive the retransmission of the second data packet 310 (shown as data packet 310-2), and, as shown by reference number 322, the receiving device may store the data packet 310-2 in the buffer 318 and/or may combine the data packet 310-1 with the data packet 310-2. As one example, the receiving device may combine the data packet 310-1 and the data packet 310-2 prior to channel decoding and/or error detection, and may process the combined data packet to mitigate errors as shown by reference number 324. That is, by processing the combined data packet, the receiving device may recover data that includes minimal errors (e.g., is error-free and/or includes a number of errors that satisfy the low error threshold). In some aspects, the receiving device may combine the data packet 310-1 and the data packet 310-2 using soft combining. “Soft combining” may denote combining multiple received signals based at least in part on a confidence and/or reliability of each received signal, such as

by combining received signals using a log likelihood ratio (LLR), to improve a signal quality of the combined data packet and reduce recovery errors.

In some aspects, the receiving device may transmit an ACK to the transmitting device, such as in scenarios where the receiving device is able to recover a version of the second data packet 310 that includes minimal errors. In other aspects, the receiving device may transmit a NACK to the transmitting device, such as in scenarios where the receiving device is unable to recover a version of the second data packet 310 with minimal errors.

A HARQ process may be used to regulate any combination of PDSCH transmissions, PUSCH transmissions, and/or physical sidelink shared channel (PSSCH) transmissions. Accordingly, the first data packet 306 and/or the second data packet 310 shown by FIG. 3 may be based at least in part on one or more PDSCH transmissions, one or more PUSCH transmissions, and/or one or more PSSCH transmissions. For PDSCH transmissions, the receiving device (e.g., a UE 120) may transmit ACK/NACK feedback via PUCCH or PUSCH. For PUSCH transmissions, the receiving device (e.g., a network node 110) may transmit ACK/NACK feedback in an uplink grant (e.g., indicated via downlink control information (DCI)). For a sidelink transmission, the receiving device (e.g., a UE 120) may transmit ACK/NACK feedback via a physical sidelink feedback channel (PSFCH).

As indicated above, FIG. 3 is provided as an example. Other examples may differ from what is described with regard to FIG. 3.

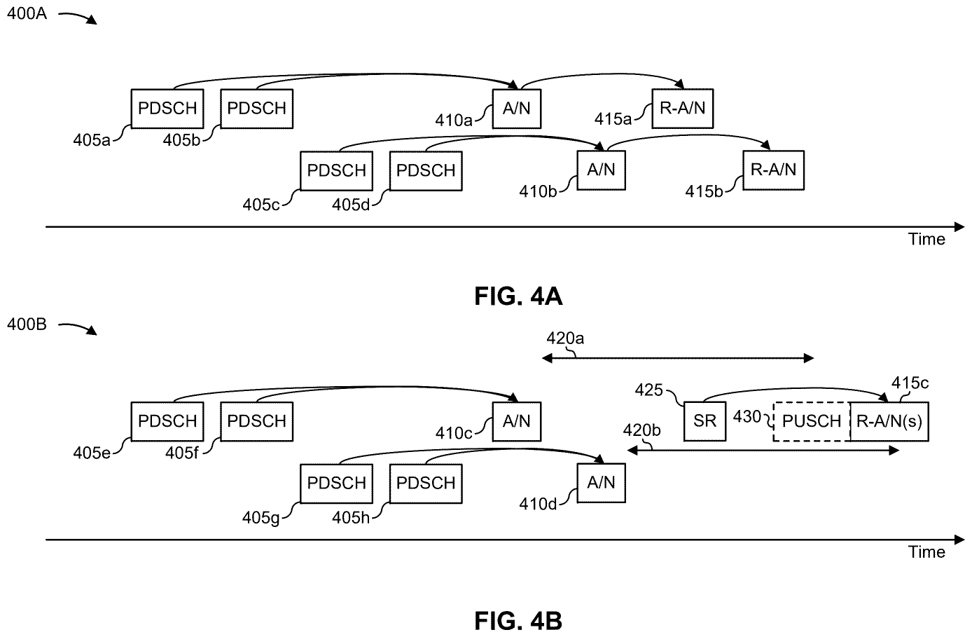

FIGS. 4A and 4B are diagrams illustrating example 400A and example 400B of uplink delayed reliable acknowledgement codebook transmission, in accordance with the present disclosure. The example 400A and the example 400B illustrate signaling that may be transmitted and/or received by a UE 120 and a network node 110, as described herein.

As shown in the example 400A illustrated by FIG. 4A, the UE 120 may receive one or more PDSCHs 405, such as a PDSCH 405a, a PDSCH 405b, a PDSCH 405c, and a PDSCH 405d, which may correspond to one or more TBs transmitted by the network node 110. The UE 120 may be configured to transmit feedback messages associated with the received PDSCHs 405. For example, the UE 120 may transmit one or more ACK/NACK (A/N) feedbacks 410, which may be an example of HARQ feedback as described herein. In some cases, the UE 120 may transmit HARQ feedback corresponding to one or more PDSCHs 405. For example, the UE 120 may transmit an A/N feedback 410 corresponding to the PDSCH 405a and the PDSCH 405b, and the UE 120 may transmit an A/N feedback 410b corresponding to the PDSCH 405c and the PDSCH 405d.

In some examples, the A/N feedback 410 may be transmitted via an uplink control resource (e.g., a PUCCH resource) associated with a downlink grant for the corresponding PDSCHs 405. For example, the A/N feedback 410a may be transmitted by the UE 120 via a PUCCH resource associated with a downlink grant for the PDSCH 405a and/or the PDSCH 405b. Accordingly, the transmission of the A/N feedback 410 may be performed using a fixed timeline, which may support HARQ functionality. For example, DCI indicating a grant for a downlink message may include a first offset (e.g., k0) from the DCI transmission that indicates an occasion for transmission of the downlink message, and a second offset (e.g., k1) from the scheduled downlink message indicating an occasion for transmission of the A/N feedback 410. In some cases, however, this fixed timeline may reduce the reliability of A/N feedback 410 transmissions, as the fixed timeline may limit the ability of the UE to adapt to variable channel conditions or the use of more reliable transmission technologies (e.g., a MAC-CE message). Accordingly, in some cases, the network node 110 may not receive or successfully decode an A/N feedback 410, such as in the case of a N2A error, and the network node 110 may not perform a retransmission of a TB even if the UE 120 performed a NACK transmission in one or more of the A/N feedback 410 transmissions. In accordance with some aspects described herein, the UE 120 or the network node 110 may be configured to transmit a reliable ACK/NACK (R-A/N) 415 corresponding to a TB. For example, the UE 120 or the network node 110 may transmit an R-A/N feedback 415a associated with the A/N feedback 410a (e.g., corresponding to the PDSCH 405a and the PDSCH 405b) and an R-A/N feedback 415b associated with the A/N feedback 410b. In some examples, an R-A/N feedback 415 may include the same feedback as a corresponding A/N feedback 410. For example, the UE 120 may transmit the A/N feedback 410a including an ACK to indicate successful reception of the corresponding TB, and the UE 120 may transmit the R-A/N feedback 415a, which may also include an ACK. In another example, the UE 120 may transmit the A/N feedback 410a including a NACK to indicate unsuccessful reception (e.g., unsuccessful decoding or no reception) of the TB, and the UE 120 may transmit the R-A/N feedback 415a, which may also include a NACK.

In some cases, such as to support a flexible transmission timeline, an R-A/N feedback 415 transmission may not support HARQ functionality and may not include redundancy version identifiers, and the R-A/N feedback 415 may instead support automatic repeat request (ARQ) functionality associated with requesting a retransmission of a TB. The R-A/N feedback 415 transmission may be delayed relative to a timeline for an A/N feedback 410 transmission, and the transmission timeline for the R-A/N feedback 415 may be more flexible, as there may not be a fixed timing or dedicated resource for the R-A/N feedback 415 transmission. Accordingly, the R-A/N feedback 415 may support increased reliability, thereby reducing error incidence for requesting retransmissions of a TB. For example, the R-A/N feedback 415 may be transmitted using a MAC-CE message, which may support increased reliability and a larger message size (e.g., relative to a PUCCH or UCI message).

In some examples, the UE 120 may transmit an R-A/N feedback 415 via an uplink resource, such as a PUSCH resource. For example, the network node 110 may have previously transmitted an uplink grant for, or otherwise configured, the uplink resource (e.g., a PUSCH resource, a configured grant PUSCH resource, or a connection-less uplink (CLUL) resource), and the uplink resource may be scheduled after the resource corresponding to the A/N feedback 410a. Accordingly, the UE 120 may perform the uplink transmission via the configured uplink resource, and the UE 120 may multiplex (e.g., piggyback) the R-A/N feedback 415a (e.g., as a MAC-CE) with a payload of the uplink message. Additionally, or alternatively, the network node 110 may transmit an uplink grant to the UE 120 (e.g., before or after transmission of the A/N feedback 410a) to provide a PUSCH resource for the R-A/N feedback 415a. For example, the UE 120 may have limited or no uplink traffic, but the network node 110 may transmit the uplink grant to provide a PUSCH resource for transmission of the R-A/N feedback 415a (e.g., even if the UE 120 has limited or no uplink traffic for transmission).

In some examples, the UE 120 may transmit an SR for resources for transmission of an R-A/N feedback 415. For example, the UE 120 may not have received an uplink grant for a PUSCH resource in which to transmit the R-A/N feedback 415. Accordingly, the UE 120 may be configured to transmit the SR, and the network node 110 may transmit an uplink grant indicating a PUSCH resource for transmission of the R-A/N feedback 415. Additionally, or alternatively, the UE 120 may transmit the R-A/N feedback 415 via a CLUL resource. For example, the UE 120 may be configured (e.g., by the network node 110) with one or more CLUL resources which may be used for small data transmissions. In some cases, the CLUL resources may be obtained from a configured PUSCH resource pool, and the CLUL resources may not be associated with a grant for transmitting via the CLUL resources, which may allow the UE 120 to directly transmit signaling via the CLUL resources. In some cases, the UE 120 may receive a configuration from the network node 110 that may indicate whether CLUL resources are configured (e.g., allowed to be used) for R-A/N transmissions.

In some examples, an R-A/N feedback 415 may additionally, or alternatively, be transmitted by the network node 110. For example, the network node 110 may receive the A/N feedback 410b transmitted by the UE 120, and the network node 110 may transmit the R-A/N feedback 415b to the UE 120 in accordance with the received A/N feedback 410b. For instance, if the network node 110 decoded the A/N feedback 410b and the A/N feedback 410b indicated an ACK, the network node 110 may transmit the R-A/N feedback 415b including an ACK. As a result, the transmission overhead may be shifted to the network node 110, thereby reducing power consumption at the UE 120. Additionally, or alternatively, the network node 110 may be configured to transmit R-A/N feedback 415 in cases when the UE 120 is operating in a power saving mode, when there is a relatively large amount of downlink traffic and/or a small amount of uplink traffic, and/or in systems where downlink traffic is more cost-efficient relative to uplink traffic (e.g., in time division duplex systems with a relative large downlink and uplink link budget imbalance, where more resources are allocated to downlink communication than to uplink communications).

In some examples, if an R-A/N feedback 415 is transmitted by the network node 110, the UE 120 may check for potential decoding errors. For example, the UE 120 may transmit the A/N feedback 410b including a NACK, but the network node 110 may decode the A/N feedback 410b codebook as an ACK and may transmit the R-A/N feedback 415b including an ACK codebook. Accordingly, the UE 120 may be configured to compare an R-A/N feedback 415 received from the network node 110 with a previously transmitted A/N feedback 410. For example, the UE 120 may store the transmitted A/N feedback 410 for a duration, and compare the A/N feedback 410 with the R-A/N feedback 415 received from the network node 110. In some cases, the UE 120 may transmit signaling (e.g., a MAC-CE message, which may be multiplexed with a PUSCH message) to the network node 110 if the comparison indicates a mismatch between the A/N feedback 410 and the R-A/N feedback 415 received from the network node 110. Accordingly, the network node 110 may determine if an error in decoding occurred (e.g., a N2A error), and may perform a retransmission of the TB (e.g., if the A/N feedback 410 included a NACK).

In some examples, the network node 110 may transmit an R-A/N feedback 415 via a downlink transmission, such as via a PDSCH message. For example, the network node 110 may transmit a MAC-CE message multiplexed with a payload of a PDSCH containing downlink data. The R-A/N feedback 415 may include information to associate the R-A/N with a corresponding HARQ feedback (e.g., an A/N feedback 410). For example, the R-A/N feedback 415 transmission (e.g., the PDSCH message or the MAC-CE message) may indicate a slot index associated with the corresponding A/N feedback 410 (e.g., a slot index at which the A/N feedback 410 was transmitted by the UE 120 and/or received by the network node 110), which may allow the UE 120 to compare the received R-A/N feedback 415 with the corresponding A/N feedback 410.

In some cases, the UE 120 and/or the network node 110 may be configured to skip transmission of an R-A/N feedback 415. For example, the UE 120 may skip the transmission of an uplink R-A/N feedback 415 based on a quantity of CRC bits of a corresponding A/N feedback 410. For example, the quantity of CRC bits (e.g., a CRC length) satisfying (e.g., exceeding) a threshold may indicate that the transmission of the A/N feedback 410 may be relatively reliable (e.g., low probability of N2A error or interpreting a discontinuous transmission as an ACK). Conversely, the quantity of CRC bits not satisfying the threshold may indicate that the transmission of the A/N feedback 410 may not be reliable (e.g., a relatively high probability of N2A error or interpreting a discontinuous transmission as an ACK). In some examples, the UE 120 may receive a configuration that indicates the threshold from the network node 110. Additionally, or alternatively, the network node 110 may skip a transmission of a downlink R-A/N feedback 415 if the network node 110 receives a corresponding A/N feedback 410 having a quantity of CRC bits that satisfies the threshold. In some cases, such as to request transmission of R-A/N feedback 415 regardless of CRC length, the network node 110 may configure the threshold to be very large, which may cause the UE 120 to transmit R-A/N feedback 415 for each A/N feedback 410. Accordingly, transmission overhead may be reduced in cases where the A/N feedback 410 transmissions are relatively reliable. In some examples, the network node 110 may be configured to treat all failed decoding of an A/N feedback 410 as a NACK, which may ensure that a retransmission of a TB is performed in case the UE 120 transmitted an A/N feedback 410 including a NACK.

As shown in the example 400B illustrated by FIG. 4B, the transmission of an R-A/N feedback 415 may be based on a timer 420. For example, the UE 120 may transmit an A/N feedback 410c corresponding to one or more TBs associated with a PDSCH 405e and a PDSCH 405f transmitted by the network node 110, and the UE 120 may transmit an A/N feedback 410d corresponding to one or more TBs associated with a PDSCH 405g and a PDSCH 405 h transmitted by the network node 110. In some examples, the UE 120 may initiate a timer 420a based on transmitting the A/N feedback 410c (e.g., before, during, or after transmitting the A/N feedback 410c) and a timer 420b based on transmitting the A/N feedback 410d.

During a duration of a timer 420, the UE 120 may store a corresponding A/N feedback 410 (e.g., an indication of the A/N feedback 410, a codebook associated with the A/N), and the UE 120 may transmit a corresponding R-A/N feedback 415 or compare the stored A/N feedback 410 with an R-A/N feedback 415 transmitted by the network node 110. In some cases, the UE 120 may wait for an uplink grant for transmission of the R-A/N feedback 415 during a duration of the timer 420. In some aspects, if the UE 120 does not receive an uplink grant and the timer 420 expires (e.g., or is close to expiring, such as based on a processing timeline for an uplink grant), the UE 120 may transmit an SR 425 for PUSCH resource 430, and the network node 110 may transmit an uplink grant based on receiving the SR 425. Accordingly, the UE 120 may transmit a PUSCH message including the R-A/N feedback 415 based on initiating the timer 420 (e.g., prior to expiration of the timer 420 or shortly after expiration of the timer 420) and based on receiving the uplink grant (e.g., based on transmitting the SR 425).

In some cases, multiple timers 420 may be running at the same time (e.g., overlapping). For example, the UE 120 may initiate the timer 420a based on transmitting the A/N feedback 410c, and the UE 120 may initiate the timer 420b based on transmitting the A/N feedback 410d, which may cause the timer 420b to overlap with the timer 420a. While the timer 420a and the timer 420b are running, the UE 120 may wait for an uplink grant to transmit a PUSCH message including corresponding R-A/N feedback 415. In some aspects, the UE 120 may transmit the SR 425 based on the timer 420a expiring (e.g., or being close to expiring, based on a processing timeline for an uplink grant and/or an uplink message). In some examples, the UE 120 may transmit a PUSCH message including R-A/N feedback 415 corresponding to one or more (e.g., all or some) pending timers 420. For example, the UE 120 may transmit a PUSCH message based on receiving an uplink grant from the network node 110, and the UE 120 may multiplex R-A/N feedback 415c corresponding to both the A/N feedback 410c and the A/N feedback 410d with a payload of the same PUSCH. Accordingly, an R-A/N feedback 415 corresponding to the A/N feedback 410d may be transmitted prior to an expiration of the timer 420b based on a transmission opportunity being available (e.g., based on the timer 420a expiring or being close to expiring).

In some examples, a duration of the timers 420 may be configured (e.g., based on one or more configurations) by the network node 110 (e.g., via an RRC message). In some examples, the network node 110 may configure a relatively long duration for timers 420, and the UE 120 may therefore wait to transmit an R-A/N feedback 415 for a longer duration. Accordingly, configuring a relatively longer timer duration may allow the UE 120 to multiplex a larger quantity of R-A/N feedback 415 together in a same PUSCH message, thereby reducing uplink overhead. In some examples, the network node 110 may configure a relatively short duration for timers 420, which may reduce the quantity of multiplexed R-A/N feedback 415 in a same PUSCH message (e.g., relative to a longer timer duration), and may allow for a smaller buffer size at the network node 110, relative to the longer timer duration for a buffer associated with storing the TB (e.g., in case of retransmission).

In some examples, the network node 110 may additionally, or alternatively, initiate a timer 420 based on reception of an A/N feedback 410. For example, the timer 420 initiated by the network node 110 may have the same duration as a timer 420 initiated by the UE 120, or the timer 420 may have a different duration from the timer 420 initiated by the UE 120 (e.g., a shorter duration accounting for a transmission and/or decoding timeline, such that both timers 420 expire at a same time). Additionally, or alternatively, the timers 420 at the UE 120 and/or the network node 110 may be initiated in accordance with a time occasion configured for transmission of a corresponding HARQ feedback (e.g., based on a K1 indication indicating an uplink slot for the HARQ feedback transmission). In some aspects, the network node 110 may monitor for an R-A/N feedback 415 prior to expiration of the timer 420. For example, the network node 110 may expect an R-A/N feedback 415 multiplexed with a payload of a PUSCH message transmitted during a duration of the timer 420. Accordingly, timers 420 may be running simultaneously at the UE 120 and the network node 110, which may improve the reliability of R-A/N feedback 415 transmissions.

In some cases, such as if there is no uplink grant for the UE 120 and the timer 420 has expired (e.g., or is close to expiring), the network node 110 may transmit an uplink grant for the UE 120 to transmit the R-A/N feedback 415, which may reduce overhead associated with transmission of an SR 425 by the UE 120. For example, the UE 120 may expect an uplink grant to be transmitted by the network node 110 prior to expiration of the timer 420 if an uplink resource has not been previously configured, and the UE 120 may transmit an SR 425 only if such an uplink grant is not received (e.g., as a backup mechanism, such as if the network node 110 is experiencing heavy traffic or is the uplink grant is transmitted but not decoded by the UE 120).

In some aspects, the UE 120 may perform multiple transmissions of an R-A/N feedback 415, which may improve transmission reliability. For example, if multiple PUSCH occasions are scheduled during a duration of a timer 420 corresponding to an R-A/N feedback 415, the UE 120 may multiplex the same R-A/N feedback 415 to payloads of each PUSCH message transmitted via the PUSCH occasions. In some cases, if the network node 110 receives (e.g., decodes) more than one R-A/N feedback 415 corresponding to the same A/N feedback 410, the network node 110 may discard one or more repeated versions of the same R-A/N feedback 415.

In some cases, if a timer 420 expires and an R-A/N feedback 415 is not received or decoded by the network node 110, the network node 110 may assume a NACK for the R-A/N feedback 415. In cases where a corresponding A/N feedback 410 (e.g., HARQ feedback) included a NACK, the network node 110 may perform a TB retransmission or may not take any further actions (e.g., if the TB retransmission was already performed). In cases where the A/N feedback 410 indicated by the HARQ feedback included an ACK, the network node 110 may perform a TB retransmission (e.g., may assume that an N2A error occurred). Accordingly, the network node 110 may be able to address N2A errors without increasing complexity (e.g., associated with error detection). In cases where the TB retransmission is redundant (e.g., if the R-A/N feedback 415 including an ACK was not received by the network node 110 and the original TB was successfully received), the UE 120 may discard (e.g., ignore) the TB retransmission.

In some examples, the timers 420 may similarly be used for downlink R-A/N feedback 415 transmissions. For example, the network node 110 may be configured to transmit an R-A/N feedback 415 prior to expiration of a timer 420 after receiving a corresponding A/N feedback 410. In some cases, the UE 120 may store an indication of the corresponding A/N feedback 410 for a duration of the timer 420. The UE 120 may compare the R-A/N feedback 415 received from the network node 110 with the stored indication of the A/N feedback 410, and the UE 120 may transmit signaling to the network node 110 if the comparison indicates a mismatch (e.g., for the network node 110 to initiate a TB retransmission). For example, the UE 120 may transmit the signaling to indicate the mismatch when the A/N feedback 410 transmitted to the network node 110 includes an ACK and the R-A/N feedback 415 received from the network node 110 includes a NACK, or when the A/N feedback 410 transmitted to the network node 110 includes a NACK and the R-A/N feedback 415 received from the network node 110 includes an ACK.

In some aspects, both downlink R-A/N feedback 415 and uplink R-A/N feedback 415 may be configured concurrently. For example, the UE 120 may be configured to transmit an uplink R-A/N feedback 415, and the network node 110 may be configured to transmit a downlink R-A/N feedback 415 if the uplink R-A/N feedback 415 is not received (e.g., based on a timer 420). Alternatively, the network node 110 may be configured to refrain from transmitting the downlink R-A/N feedback 415 if the uplink R-A/N feedback 415 is received. Similarly, the network node 110 may be configured to transmit a downlink R-A/N feedback 415 based on reception of an A/N feedback 410, and the UE 120 may be configured to transmit an uplink R-A/N feedback 415 if the downlink R-A/N feedback 415 is not received (e.g., based on a timer 420) or to refrain from transmitting the uplink R-A/N feedback 415 if the downlink R-A/N feedback 415 is received.

Accordingly, by transmitting an R-A/N feedback 415 after an A/N feedback 410 transmission, the UE 120 and the network node 110 may support increased reliability associated with TB feedback, which may improve TB reception at the UE 120 without increasing complexity or overhead associated with N2A error detection and missing DCI detection, for example.

As indicated above, FIGS. 4A and 4B are provided as examples. Other examples may differ from what is described with respect to FIGS. 4A and 4B.

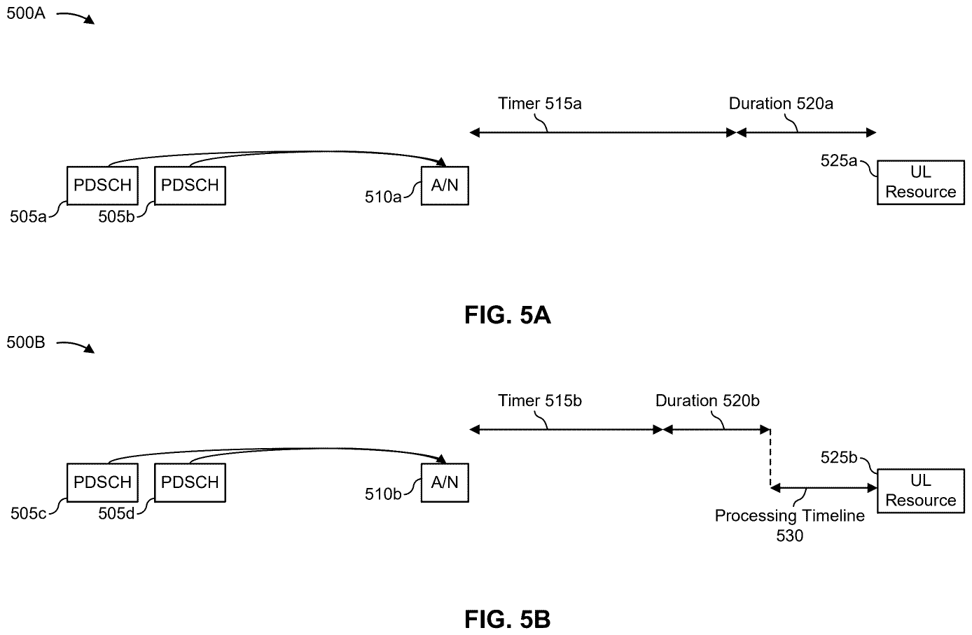

FIGS. 5A and 5B are diagrams illustrating example 500A and example 500B of uplink delayed reliable acknowledgement codebook transmission, in accordance with the present disclosure. The example 500A and the example 500B illustrate signaling that may be transmitted and/or received by a UE 120 and a network node 110, as described herein.

As shown in the example 500A illustrated by FIG. 5A, the UE 120 may receive a PDSCH 505a and a PDSCH 505b associated with one or more TBs, and the UE 120 may transmit an A/N feedback 510a (e.g., HARQ feedback) associated with the one or more TBs, as described herein. In some examples, the UE 120 may initiate a timer 515a based on transmission of the A/N feedback 510a, and the timer 515a may have a duration configured by the network node 110 (e.g., via one or more RRC messages), as described herein.

In some cases, however, the UE 120 may not be configured with any resources (e.g., PUSCH resources) for transmission of R-A/N feedback. Additionally, or alternatively, SR resources and CLUL resources may be configured (e.g., via one or more RRC messages) in accordance with a periodic structure, which may result in the expiration of the timer 515a not aligning with a configured SR resource for transmission of an SR to request an uplink grant or with a configured CLUL resource for transmission a CLUL message including the R-A/N.

In accordance with some examples as described herein, the UE 120 may adjust a duration of the timer 515a. For example, the UE 120 may extend a configured duration of the timer 515a based on a duration 520a, such that the timer 515a may align with an uplink resource 525a. The resource 525a may be an SR resource for transmission of an SR to request an uplink grant for transmission of a PUSCH message including the R-A/N. Additionally, or alternatively, the uplink resource 525a may be a CLUL resource that may be used for transmission of R-A/N feedback.

In some examples, the duration 520a may extend the duration of the timer 515a such that the timer 515a expires at a start of the uplink resource 525a (e.g., based on a starting symbol of the uplink resource 525a). In some other examples, the duration 520a may extend the duration of the timer 515a such that the timer 515a expires at an end of the uplink resource 525a (e.g., based on an ending symbol of the uplink resource 525a), or after the end of the uplink resource 525a. For example, the timer 515a may be further extended to allow for transmission of a PUSCH message scheduled by the network node 110 after transmitting the SR prior to expiration of the timer 515a.

As shown in the example 500B illustrated by FIG. 4B, the UE 120 may receive a PDSCH 505c and a PDSCH 505d associated with one or more TBs, and the UE 120 may transmit an A/N feedback 510b (e.g., HARQ feedback) associated with the one or more TBs, as described herein. In some examples, the UE 120 may initiate a timer 515b based on transmission of the A/N feedback 510b, and the timer 515b may have a duration configured by the network node 110 (e.g., via one or more RRC messages), as described herein. Additionally, a duration of the timer 515b may be adjusted in accordance with a next available uplink resource 525b, which may be an example of an SR resource or a CLUL resource, as described herein.

In some examples, the timer 515b may additionally be adjusted based on a processing timeline 530 associated with the SR resource or the CLUL resource. For example, the UE 120 may be associated with a processing timeline 530 for preparing an SR for transmission, processing a received uplink grant, preparing a PUSCH for transmission, preparing a CLUL message (e.g., a CLUL PUSCH message) for transmission, or a combination thereof.

For example, the UE 120 may monitor for an uplink grant during the timer 515b. As the UE 120 may not have time to prepare a message for transmission via the uplink resource 525b scheduled by such an uplink grant due to the processing timeline 530, the timer 515b may not be extended to the start of the uplink resource 525b. For example, if the processing timeline 530 includes N symbols, the timer 515b may be extended by a duration 520b such that the timer 515b expires N symbols prior to the uplink resource 525b (e.g., prior to the start or end of the uplink resource 525b). Accordingly, the UE 120 may avoid monitoring for uplink grants for at least some duration where the UE 120 would not have time to prepare an uplink message even if such an uplink grant was received, thereby reducing overhead and power consumption for the UE 120.

In some examples, the processing timeline 530 may be the same or different for different UEs 120 (e.g., based on capabilities of the different UEs 120). For example, the processing timeline 530 may be configured by the UE 120 based on a respective processing duration experienced (for example, or observed) by the UE 120. Additionally, or alternatively, the processing timeline 530 may be the same or different for different types of uplink resources 525. For example, the processing timeline 530 may be different for SR resources and CLUL resources (e.g., due to different processing times for preparing respective messages). Accordingly, the timer 515b may be adjusted differently depending on whether the next uplink resource 525b is an SR resource or a CLUL resource.

As indicated above, FIGS. 5A and 5B are provided as examples. Other examples may differ from what is described with respect to FIGS. 5A and 5B.

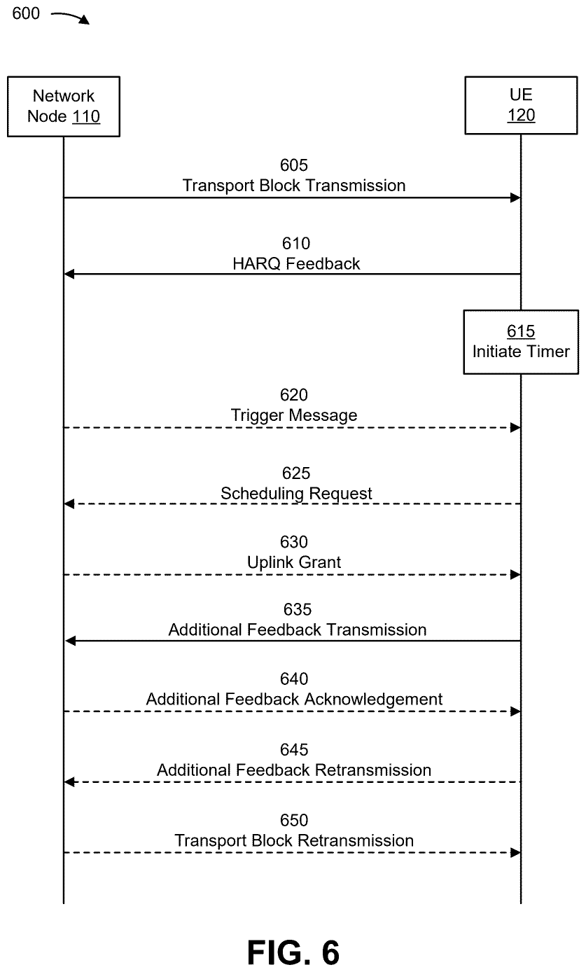

FIG. 6 is a diagram of an example 600 associated with uplink delayed reliable acknowledgement codebook transmission, in accordance with the present disclosure. As shown in FIG. 6, a network node 110 (e.g., a network node 110, a CU, a DU, and/or an RU, as described herein) may communicate with a UE 120. In some aspects, the network node 110 and the UE 120 may be part of a wireless network (e.g., wireless network 100). The UE 120 and the network node 110 may have established a wireless connection prior to operations shown in FIG. 6.

As shown by reference number 605, the network node 110 may transmit, and the UE 120 may receive, a TB. In some examples, the TB transmission may include one or more messages (e.g., one or more downlink messages, such as PDSCH messages). In some cases, the TB transmission may be associated with an occasion for transmission of HARQ feedback by the UE 120, as described herein. For example, the network node 110 may configure one or more resources (e.g., uplink resources) for transmission of the HARQ feedback.

As shown by reference number 610, the UE 120 may transmit, and the network node 110 may receive, a message including HARQ feedback associated with the TB transmission. For example, the UE 120 may transmit the message including the HARQ feedback via the one or more resources configured by the network node 110.

As shown by reference number 615, the UE 120 may initiate a timer based on transmission of the message including the HARQ feedback, as described herein. For example, the UE 120 may initiate the timer after or during the transmission of the message including the HARQ feedback. The timer may be associated with a transmission of additional feedback (e.g., R-A/N feedback) corresponding to the TB.

In some cases, as shown by the reference number 620, the network node 110 may transmit, and the UE 120 may receive, a trigger message. The trigger message may indicate that the UE 120 is to transmit the additional feedback associated with the TB. In some examples, the trigger message may be a query (e.g., a request) for the additional feedback. Additionally, or alternatively, the trigger message may include a grant (e.g., an uplink grant) for transmission of a message including the additional feedback. In some cases, the network node 110 may transmit the trigger message based on expiration of an additional timer at the network node 110. For example, the network node 110 may initiate the additional timer based on reception of the HARQ feedback from the UE 120. In some cases, the network node 110 may transmit the trigger message based on expiration of the additional timer. For example, the network node 110 may transmit the trigger message if the network node 110 has not received (for example, or detected) a message from the UE 120 including the additional feedback.

As shown by reference number 625, the UE 120 may transmit, and the network node 110 may receive, an SR. For example, the UE 120 may request a grant (e.g., an uplink grant) for transmission of a message including the additional feedback. In some examples, the UE 120 may transmit the SR based on an absence of an uplink resource during a duration of the timer, near (e.g., within a threshold duration) an expiration of the timer, or both. Additionally, or alternatively, the UE 120 may transmit the SR based on the timer expiring and the UE 120 not having received a grant for transmission of the additional feedback.

As shown by reference number 630, the network node 110 may transmit, and the UE 120 may receive, an uplink grant. The uplink grant may indicate one or more uplink resources for transmission of a message including the additional feedback. In some examples, the network node 110 may transmit the uplink grant based on receiving the SR from the UE 120. Additionally, or alternatively, the network node 110 may transmit the uplink grant based on expiration of the additional timer at the network node 110, based on not receiving a message including the additional feedback from the UE 120, or both.

As shown by reference number 635, the UE 120 may transmit, and the network node 110 may receive, a second message that includes the additional feedback (e.g., an R-A/N) associated with the TB. In some examples, the second message may be an uplink message (e.g., a PUSCH), which may be transmitted via one or more resources indicated in the uplink grant. In some cases, the second message may include the additional feedback multiplexed (e.g., piggybacked) with a payload of the uplink message. For example, the second message may include a MAC-CE message that indicates the additional feedback. In some examples, the transmission of the second message including the additional feedback may be based on the timer. For example, the UE 120 may be configured to transmit the second message including the additional feedback prior to an expiration of the timer. In some other examples, the UE 120 may be configured to transmit the second message including the additional feedback based on the expiration of the timer. Additionally, or alternatively, the UE 120 may transmit the second message including the additional feedback based on reception of the trigger message.

As shown by reference number 640, the network node 110 may transmit, and the UE 120 may receive, an acknowledgment associated with the additional feedback transmission. For example, the network node 110 may transmit a message indicating a positive acknowledgment (e.g., an ACK) to the UE 120 based on receiving the second message including the additional feedback from the UE 120. Alternatively, the network node 110 may transmit a message indicating a negative acknowledgment (e.g., a NACK) to the UE 120 based on not receiving a message including the additional feedback (e.g., by expiration of the additional timer). In some other examples, the network node 110 may refrain from transmitting any acknowledgment associated with the additional feedback transmission if the additional feedback is not received. In some examples, the acknowledgment associated with the additional feedback may be transmitted via a MAC-CE message.

As shown by reference number 645, the UE 120 may perform a retransmission of the additional feedback. For example, the UE 120 may transmit, and the network node 110 may receive, an additional message including the additional feedback. In some examples, the retransmission of the additional feedback may be based on not receiving an acknowledgment associated with the additional feedback from the network node 110. For example, the UE 120 may initiate a second timer based on transmission of the second message including the additional feedback, and the UE 120 may perform the retransmission of the additional feedback if the acknowledgment associated with the additional feedback is not received before an expiration of the second timer. Additionally, or alternatively, the UE 120 may perform the retransmission of the additional feedback based on receiving a negative acknowledgment from the network node 110.

As shown by reference number 650, the network node 110 may perform a retransmission of the TB. For example, the network node 110 may decode the HARQ feedback which may indicate an ACK, and the network node 110 may decode the additional feedback indicating a NACK. Accordingly, the network node 110 may transmit, and the UE 120 may receive, the retransmission of the TB. Alternatively, the network node 110 may perform the retransmission of the TB based on HARQ feedback and the additional feedback both indicating a NACK (e.g., based on decoding by the network node 110), or based on not receiving the additional feedback (e.g., or not being able to decode the additional feedback). The UE 120 may monitor for the TB retransmission. Alternatively, such as if the UE 120 previously decoded the TB successfully, the UE 120 may ignore the retransmission.

Accordingly, the network node 110 may determine whether to transmit a retransmission of the TB based on the additional feedback transmission, which may improve the reliability of the TB relative to relying on HARQ feedback only.

As indicated above, FIG. 6 is provided as an example. Other examples may differ from what is described with respect to FIG. 6.

FIG. 7 is a diagram of an example 700 associated with uplink delayed reliable acknowledgement codebook transmission, in accordance with the present disclosure. As shown in FIG. 7, a network node 110 (e.g., a network node 110, a CU, a DU, and/or an RU, as described herein) may communicate with a UE 120. In some aspects, the network node 110 and the UE 120 may be part of a wireless network (e.g., wireless network 100). The UE 120 and the network node 110 may have established a wireless connection prior to operations shown in FIG. 7.

As shown by reference number 705, the network node 110 may transmit, and the UE 120 may receive, a TB. In some examples, the TB transmission may include one or more messages (e.g., one or more downlink messages, such as PDSCH messages). In some cases, the TB transmission may be associated with an occasion for transmission of HARQ feedback by the UE 120, as described herein. For example, the network node 110 may configure one or more resources (e.g., uplink resources) for transmission of the HARQ feedback.

As shown by reference number 710, the UE 120 may transmit, and the network node 110 may receive, a message including HARQ feedback associated with the TB transmission. For example, the UE 120 may transmit the message including the HARQ feedback via the one or more resources configured by the network node. In some examples, the UE 120 may be configured to store an indication of the HARQ feedback for a duration (e.g., based on a timer) after transmission of the message including the HARQ feedback. In some cases, the UE 120 may discard the stored indication of the HARQ feedback after expiration of the timer.

As shown by reference number 715, the network node 110 may initiate a timer based on the message including the HARQ feedback, as described herein. For example, the network node 110 may initiate the timer after or during reception of the message including the HARQ feedback. The timer may be associated with a transmission of additional feedback (e.g., an R-A/N) corresponding to the TB.

As shown by reference number 720, the network node 110 may transmit, and the UE 120 may receive, a second message that includes the additional feedback (e.g., an R-A/N) associated with the TB. The additional feedback may be based on reception of the HARQ feedback. For example, the network node 110 may decode the HARQ feedback, which may indicate an ACK, and the network node 110 may transmit the additional feedback including an ACK. Alternatively, the network node 110 may decode the HARQ feedback, which may indicate a NACK, and the network node 110 may transmit the additional feedback including a NACK. In some cases, if the network node 110 failed to decode the HARQ feedback, the network node 110 may transmit the additional feedback including a NACK. In some examples, the network node 110 may use a same codebook size for the additional feedback as a codebook size associated with the HARQ feedback.

In some examples, the second message may be a downlink message (e.g., a PDSCH). In some cases, the second message may include the additional feedback multiplexed (e.g., piggybacked) with a payload of the downlink message. For example, the second message may include a MAC-CE message that indicates the additional feedback. In some examples, the transmission of the second message including the additional feedback may be based on the timer. For example, the network node 110 may be configured to transmit the second message including the additional feedback prior to an expiration of the timer. In some other examples, the network node 110 may be configured to transmit the second message including the additional feedback based on the expiration of the timer.

As shown by reference number 725, the UE 120 may compare the HARQ feedback with the additional feedback received from the network node 110, for example, based on storing the indication of the HARQ feedback for the duration. In some cases, if the second message including the additional feedback is received after the duration, the UE 120 may perform the comparison if the indication of the HARQ feedback is still stored, or the UE 120 may ignore the additional feedback (e.g., if the indication is not stored). The UE 120 may determine whether a mismatch occurred (e.g., an error). For example, the UE 120 may determine whether the HARQ feedback included an ACK but the additional feedback indicated a NACK, or whether the HARQ feedback included a NACK but the additional feedback indicated an ACK.

As shown by reference number 730, the UE 120 may transmit, and the network node 110 may receive, an indication of a mismatch based on comparing the HARQ feedback with the additional feedback. For example, the UE 120 may detect a mismatch if the HARQ feedback indicated a NACK, but the additional feedback indicated an ACK. Accordingly, the UE 120 may transmit the indication of the mismatch, which may request a retransmission of the TB. In some cases, the UE 120 may refrain from transmitting the indication of the mismatch, even if the UE 120 detected a mismatch. For example, the UE 120 may detect that the HARQ feedback included an ACK, but the additional feedback indicated an ACK, and the UE 120 may refrain from transmitting the indication of the mismatch (e.g., and the UE 120 may ignore a future retransmission of the TB), which may decrease transmission overhead and power consumption at the UE 120. Additionally, or alternatively, the UE 120 may transmit the indication of the mismatch if the UE 120 receives the additional feedback (e.g., indicating an ACK) but the UE 120 has not (e.g., recently) transmitted a corresponding HARQ feedback. For example, the additional feedback may be based on the network node 110 mistakenly decoding an uplink message as HARQ feedback (e.g., due to missing DCI), and the UE 120 may transmit the indication of the mismatch (e.g., indexed by position in the codebook used by the additional feedback). In some examples, the indication of the mismatch may be transmitted via a MAC-CE message (e.g., which may be multiplexed with an uplink message).

As shown by reference number 735, the network node 110 may perform a retransmission of the TB. For example, the network node 110 may transmit, and the UE 120 may receive, the retransmission of the TB based on receiving a mismatch indication from the UE 120. Additionally, or alternatively, the network node 110 may perform the retransmission of the TB based on the indication of the mismatch indicating that the HARQ feedback included a NACK. The UE 120 may monitor for the TB retransmission. Alternatively, such as if the UE 120 previously decoded the TB successfully, the UE 120 may ignore the retransmission.

Accordingly, the network node 110 may determine whether to transmit a retransmission of the TB based on transmitting the additional feedback transmission and whether an indication of a mismatch was received from the UE 120, which may improve the reliability of the TB relative to relying on HARQ feedback only. Additionally, relative to the example 600 described with reference to FIG. 6, the example 700 may reduce overhead and power consumption at the UE 120, and may shift the overhead to the network node 110, which may have a higher capability for additional feedback transmissions.

As indicated above, FIG. 7 is provided as an example. Other examples may differ from what is described with respect to FIG. 7.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with delayed reliable acknowledgment transmission.

As shown in FIG. 8, in some aspects, process 800 may include transmitting, to a network node, a first message comprising HARQ feedback associated with a TB (block 810). For example, the UE (e.g., using transmission component 1004 and/or communication manager 1006, depicted in FIG. 10) may transmit, to a network node, a first message comprising HARQ feedback associated with a TB, as described above.

As further shown in FIG. 8, in some aspects, process 800 may include initiating a timer based at least in part on transmitting the first message (block 820). For example, the UE (e.g., using communication manager 1006, depicted in FIG. 10) may initiate a timer based at least in part on transmitting the first message, as described above.

As further shown in FIG. 8, in some aspects, process 800 may include transmitting a second message that includes additional feedback associated with the first message prior to an expiration of the timer (block 830). For example, the UE (e.g., using transmission component 1004 and/or communication manager 1006, depicted in FIG. 10) may transmit a second message that includes additional feedback associated with the first message prior to an expiration of the timer, as described above.

Process 800 may include additional aspects, such as any single aspect or any combination of aspects described below and/or in connection with one or more other processes described elsewhere herein.

In a first aspect, the second message is a PUSCH message that includes a payload multiplexed with the additional feedback.

In a second aspect, alone or in combination with the first aspect, process 800 includes transmitting, prior to the expiration of the timer, another PUSCH message that includes a payload that is multiplexed with the additional feedback.

In a third aspect, alone or in combination with one or more of the first and second aspects, process 800 includes transmitting, to the network node, an SR prior to the expiration of the timer, and receiving, from the network node, an uplink grant based at least in part on the SR, wherein transmitting the PUSCH message is based at least in part on the uplink grant.

In a fourth aspect, alone or in combination with one or more of the first through third aspects, process 800 includes monitoring, during a duration of the timer, for a downlink message including a positive acknowledgment associated with the second message.

In a fifth aspect, alone or in combination with one or more of the first through fourth aspects, process 800 includes transmitting, after an expiration of the timer, a third message including the additional feedback based at least in part on not receiving the downlink message during the duration of the timer.

In a sixth aspect, alone or in combination with one or more of the first through fifth aspects, process 800 includes storing, for a duration of the timer, the HARQ feedback based at least in part on initiating the timer, and receiving, during the duration of the timer, a trigger message from the network node, wherein the second message is transmitted based at least in part on receiving the trigger message during the duration of the timer.

In a seventh aspect, alone or in combination with one or more of the first through sixth aspects, the second message is transmitted using a connection-less uplink resource.

In an eighth aspect, alone or in combination with one or more of the first through seventh aspects, process 800 includes initiating another timer associated with other HARQ feedback associated with another TB, wherein the second message includes additional feedback associated with the HARQ feedback and the other HARQ feedback based at least in part on the timer overlapping with the other timer.

In a ninth aspect, alone or in combination with one or more of the first through eighth aspects, process 800 includes increasing a duration of the timer based at least in part on an upcoming SR resource, an upcoming connection-less uplink resource, or both.

In a tenth aspect, alone or in combination with one or more of the first through ninth aspects, process 800 includes adjusting a duration of the timer based at least in part on a processing timeline associated with an uplink grant for an uplink transmission, generating an SR, generating a connection-less uplink message, or a combination thereof.

In an eleventh aspect, alone or in combination with one or more of the first through tenth aspects, the second message comprises ARQ feedback that includes the additional feedback.

In a twelfth aspect, alone or in combination with one or more of the first through eleventh aspects, the HARQ feedback comprises a positive ACK or a NACK.

In a thirteenth aspect, alone or in combination with one or more of the first through twelfth aspects, transmitting the second message is based at least in part on a CRC associated with the HARQ feedback having a length that fails to satisfy a threshold.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

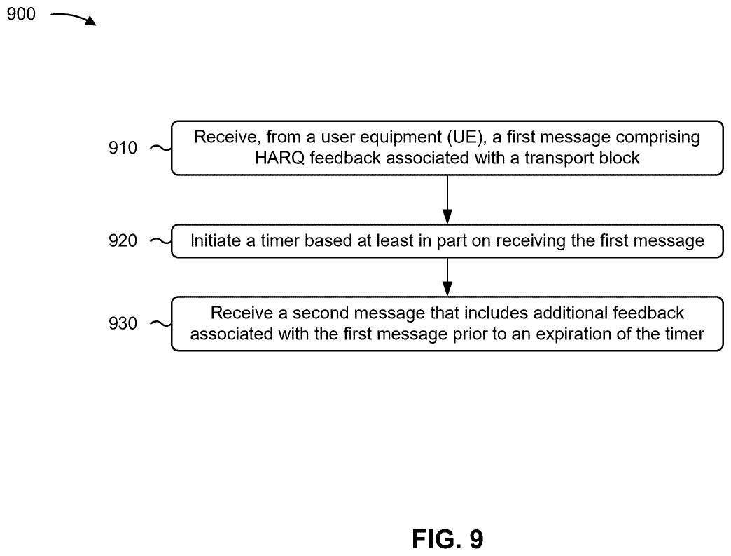

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with delayed reliable acknowledgment transmission.

As shown in FIG. 9, in some aspects, process 900 may include receiving, from a UE, a first message comprising HARQ feedback associated with a TB (block 910). For example, the network node (e.g., using reception component 1102 and/or communication manager 1106, depicted in FIG. 11) may receive, from a UE, a first message comprising HARQ feedback associated with a TB, as described above.

As further shown in FIG. 9, in some aspects, process 900 may include initiating a timer based at least in part on receiving the first message (block 920). For example, the network node (e.g., using communication manager 1106, depicted in FIG. 11) may initiate a timer based at least in part on receiving the first message, as described above.

As further shown in FIG. 9, in some aspects, process 900 may include receiving a second message that includes additional feedback associated with the first message prior to an expiration of the timer (block 930). For example, the network node (e.g., using reception component 1102 and/or communication manager 1106, depicted in FIG. 11) may receive a second message that includes additional feedback associated with the first message prior to an expiration of the timer, as described above.

Process 900 may include additional aspects, such as any single aspect or any combination of aspects described below and/or in connection with one or more other processes described elsewhere herein.

In a first aspect, process 900 includes transmitting, to the UE, an uplink grant for the second message during a duration of the timer, wherein receiving the second message is based at least in part on transmitting the uplink grant.

In a second aspect, alone or in combination with the first aspect, process 900 includes refraining from transmitting a message including additional downlink feedback associated with the first message to the UE based at least in part on receiving the second message.

In a third aspect, alone or in combination with one or more of the first and second aspects, the second message is a PUSCH message that includes a payload of the PUSCH message multiplexed with the additional feedback.

In a fourth aspect, alone or in combination with one or more of the first through third aspects, process 900 includes receiving, prior to the expiration of the timer, another PUSCH message that includes a payload multiplexed with the additional feedback.

In a fifth aspect, alone or in combination with one or more of the first through fourth aspects, process 900 includes receiving, from the UE, an SR prior to the expiration of the timer, and transmitting, to the UE, an uplink grant based at least in part on the SR, wherein receiving the PUSCH message is based at least in part on the uplink grant.

In a sixth aspect, alone or in combination with one or more of the first through fifth aspects, process 900 includes receiving, after an expiration of the timer, a third message including the additional feedback based at least in part on not transmitting a downlink message to the UE that includes additional downlink feedback associated with the first message.

In a seventh aspect, alone or in combination with one or more of the first through sixth aspects, process 900 includes transmitting, during a duration of the timer, a trigger message to the UE, wherein the second message is received based at least in part on transmitting the trigger message.

In an eighth aspect, alone or in combination with one or more of the first through seventh aspects, the second message is received via a connection-less uplink resource.

In a ninth aspect, alone or in combination with one or more of the first through eighth aspects, process 900 includes receiving other HARQ feedback associated with another TB, and initiating another timer based at least in part on receiving the other HARQ feedback, wherein the second message includes additional feedback associated with the HARQ feedback and the other HARQ feedback based at least in part on the timer overlapping with the other timer.

In a tenth aspect, alone or in combination with one or more of the first through ninth aspects, process 900 includes increasing a duration of the timer based at least in part on an upcoming SR resource, an upcoming connection-less uplink resource, or both.

In an eleventh aspect, alone or in combination with one or more of the first through tenth aspects, process 900 includes adjusting a duration of the timer based at least in part on a processing timeline associated with an uplink grant for an uplink transmission, generating an SR, generating a connection-less uplink message, or a combination thereof.

In a twelfth aspect, alone or in combination with one or more of the first through eleventh aspects, the second message comprises ARQ feedback that includes the additional feedback.

In a thirteenth aspect, alone or in combination with one or more of the first through twelfth aspects, the HARQ feedback comprises a positive ACK or a negative NACK.

In a fourteenth aspect, alone or in combination with one or more of the first through thirteenth aspects, receiving the second message is based at least in part on a CRC associated with the HARQ feedback having a length that fails to satisfy a threshold.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

In some aspects, the apparatus 1000 may be configured to perform one or more operations described herein in connection with FIGS. 4A-4B, FIGS. 5A-5B, FIG. 6, and/or FIG. 7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the UE described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit, to a network node, a first message comprising HARQ feedback associated with a TB. The communication manager 1006 may initiate a timer based at least in part on transmitting the first message. The transmission component 1004 may transmit a second message that includes additional feedback associated with the first message prior to an expiration of the timer.

The transmission component 1004 may transmit, prior to the expiration of the timer, another PUSCH message that includes a payload that is multiplexed with the additional feedback.

The transmission component 1004 may transmit, to the network node, an SR prior to the expiration of the timer.

The reception component 1002 may receive, from the network node, an uplink grant based at least in part on the SR, wherein transmitting the PUSCH message is based at least in part on the uplink grant.

The communication manager 1006 may monitor, during a duration of the timer, for a downlink message including a positive acknowledgment associated with the second message.

The transmission component 1004 may transmit, after an expiration of the timer, a third message including the additional feedback based at least in part on not receiving the downlink message during the duration of the timer.

The communication manager 1006 may store, for a duration of the timer, the HARQ feedback based at least in part on initiating the timer.

The reception component 1002 may receive, during the duration of the timer, a trigger message from the network node, wherein the second message is transmitted based at least in part on receiving the trigger message during the duration of the timer.

The communication manager 1006 may initiate another timer associated with other HARQ feedback associated with another TB, wherein the second message includes additional feedback associated with the HARQ feedback and the other HARQ feedback based at least in part on the timer overlapping with the other timer.

The communication manager 1006 may increase a duration of the timer based at least in part on an upcoming SR resource, an upcoming connection-less uplink resource, or both.

The communication manager 1006 may adjust a duration of the timer based at least in part on a processing timeline associated with an uplink grant for an uplink transmission, generating an SR, generating a connection-less uplink message, or a combination thereof.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 155 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 145 described in connection with FIG. 1) of the network node.

In some aspects, the apparatus 1100 may be configured to perform one or more operations described herein in connection with FIGS. 4A-4B, FIGS. 5A-5B, FIG. 6, and/or FIG. 7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the network node described above in connection with FIG. 1, such as a radio, one or more RF chains, one or more transceivers, or one or more modems, each of which may in turn be coupled with one or more antennas of the network node. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive, from a UE, a first message comprising HARQ feedback associated with a TB. The communication manager 1106 may initiate a timer based at least in part on receiving the first message. The reception component 1102 may receive a second message that includes additional feedback associated with the first message prior to an expiration of the timer.

The transmission component 1104 may transmit, to the UE, an uplink grant for the second message during a duration of the timer, wherein receiving the second message is based at least in part on transmitting the uplink grant.

The communication manager 1106 may refrain from transmitting a message including additional downlink feedback associated with the first message to the UE based at least in part on receiving the second message.

The reception component 1102 may receive, prior to the expiration of the timer, another PUSCH message that includes a payload multiplexed with the additional feedback.

The reception component 1102 may receive, from the UE, an SR prior to the expiration of the timer.

The transmission component 1104 may transmit, to the UE, an uplink grant based at least in part on the SR, wherein receiving the PUSCH message is based at least in part on the uplink grant.

The reception component 1102 may receive, after an expiration of the timer, a third message including the additional feedback based at least in part on not transmitting a downlink message to the UE that includes additional downlink feedback associated with the first message.

The transmission component 1104 may transmit, during a duration of the timer, a trigger message to the UE, wherein the second message is received based at least in part on transmitting the trigger message.

The reception component 1102 may receive other HARQ feedback associated with another TB.

The communication manager 1106 may initiate another timer based at least in part on receiving the other HARQ feedback, wherein the second message includes additional feedback associated with the HARQ feedback and the other HARQ feedback based at least in part on the timer overlapping with the other timer.

The communication manager 1106 may increase a duration of the timer based at least in part on an upcoming SR resource, an upcoming connection-less uplink resource, or both.

The communication manager 1106 may adjust a duration of the timer based at least in part on a processing timeline associated with an uplink grant for an uplink transmission, generating an SR, generating a connection-less uplink message, or a combination thereof.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a UE, comprising: transmitting, to a network node, a first message comprising HARQ feedback associated with a TB; initiating a timer based at least in part on transmitting the first message; and transmitting a second message that includes additional feedback associated with the first message prior to an expiration of the timer.

Aspect 2: The method of Aspect 1, wherein the second message is a PUSCH message that includes a payload multiplexed with the additional feedback.

Aspect 3: The method of Aspect 2, further comprising: transmitting, prior to the expiration of the timer, another PUSCH message that includes a payload that is multiplexed with the additional feedback.

Aspect 4: The method of Aspect 2, further comprising: transmitting, to the network node, an SR prior to the expiration of the timer; and receiving, from the network node, an uplink grant based at least in part on the SR, wherein transmitting the PUSCH message is based at least in part on the uplink grant.

Aspect 5: The method of any of Aspects 1-4, further comprising: monitoring, during a duration of the timer, for a downlink message including a positive acknowledgment associated with the second message.

Aspect 6: The method of Aspect 5, further comprising: transmitting, after an expiration of the timer, a third message including the additional feedback based at least in part on not receiving the downlink message during the duration of the timer.

Aspect 7: The method of any of Aspects 1-6, further comprising: storing, for a duration of the timer, the HARQ feedback based at least in part on initiating the timer; and receiving, during the duration of the timer, a trigger message from the network node, wherein the second message is transmitted based at least in part on receiving the trigger message during the duration of the timer.

Aspect 8: The method of any of Aspects 1-7, wherein the second message is transmitted using a connection-less uplink resource.

Aspect 9: The method of any of Aspects 1-8, further comprising: initiating another timer associated with other HARQ feedback associated with another TB, wherein the second message includes additional feedback associated with the HARQ feedback and the other HARQ feedback based at least in part on the timer overlapping with the other timer.

Aspect 10: The method of any of Aspects 1-9, further comprising: increasing a duration of the timer based at least in part on an upcoming SR resource, an upcoming connection-less uplink resource, or both.

Aspect 11: The method of any of Aspects 1-10, further comprising: adjusting a duration of the timer based at least in part on a processing timeline associated with an uplink grant for an uplink transmission, generating an SR, generating a connection-less uplink message, or a combination thereof.

Aspect 12: The method of any of Aspects 1-11, wherein the second message comprises ARQ feedback that includes the additional feedback.

Aspect 13: The method of any of Aspects 1-12, wherein the HARQ feedback comprises an ACK or a NACK.

Aspect 14: The method of any of Aspects 1-13, wherein transmitting the second message is based at least in part on a CRC associated with the HARQ feedback having a length that fails to satisfy a threshold.

Aspect 15: A method of wireless communication performed by a network node, comprising: receiving, from a UE, a first message comprising HARQ feedback associated with a TB; initiating a timer based at least in part on receiving the first message; and receiving a second message that includes additional feedback associated with the first message prior to an expiration of the timer.

Aspect 16: The method of Aspect 15, further comprising: transmitting, to the UE, an uplink grant for the second message during a duration of the timer, wherein receiving the second message is based at least in part on transmitting the uplink grant.

Aspect 17: The method of any of Aspects 15-16, further comprising: refraining from transmitting a message including additional downlink feedback associated with the first message to the UE based at least in part on receiving the second message.

Aspect 18: The method of any of Aspects 15-17, wherein the second message is a PUSCH message that includes a payload of the PUSCH message multiplexed with the additional feedback.

Aspect 19: The method of Aspect 18, further comprising: receiving, prior to the expiration of the timer, another PUSCH message that includes a payload multiplexed with the additional feedback.

Aspect 20: The method of Aspect 18, further comprising: receiving, from the UE, an SR prior to the expiration of the timer; and transmitting, to the UE, an uplink grant based at least in part on the SR, wherein receiving the PUSCH message is based at least in part on the uplink grant.

Aspect 21: The method of any of Aspects 15-20, further comprising: receiving, after an expiration of the timer, a third message including the additional feedback based at least in part on not transmitting a downlink message to the UE that includes additional downlink feedback associated with the first message.

Aspect 22: The method of any of Aspects 15-21, further comprising: transmitting, during a duration of the timer, a trigger message to the UE, wherein the second message is received based at least in part on transmitting the trigger message.

Aspect 23: The method of any of Aspects 15-22, wherein the second message is received via a connection-less uplink resource.

Aspect 24: The method of any of Aspects 15-23, further comprising: receiving other HARQ feedback associated with another TB; and initiating another timer based at least in part on receiving the other HARQ feedback, wherein the second message includes additional feedback associated with the HARQ feedback and the other HARQ feedback based at least in part on the timer overlapping with the other timer.

Aspect 25: The method of any of Aspects 15-24, further comprising: increasing a duration of the timer based at least in part on an upcoming SR resource, an upcoming connection-less uplink resource, or both.

Aspect 26: The method of any of Aspects 15-25, further comprising: adjusting a duration of the timer based at least in part on a processing timeline associated with an uplink grant for an uplink transmission, generating an SR, generating a connection-less uplink message, or a combination thereof.

Aspect 27: The method of any of Aspects 15-26, wherein the second message comprises ARQ feedback that includes the additional feedback.

Aspect 28: The method of any of Aspects 15-27, wherein the HARQ feedback comprises a ACK or a NACK.

Aspect 29: The method of any of Aspects 15-28, wherein receiving the second message is based at least in part on a CRC associated with the HARQ feedback having a length that fails to satisfy a threshold.

Aspect 30: A method of wireless communication performed by UE, comprising: transmitting, to a network node, a first message comprising HARQ feedback associated with a TB; and receiving, from the network node, a second message that includes additional feedback associated with the first message.

Aspect 31: The method of Aspect 30, further comprising: transmitting a third message to the network node based at least in part on a mismatch between the HARQ feedback and the additional feedback; and receiving a retransmission of the TB based at least in part on the third message.

Aspect 32: The method of Aspect 31, wherein the third message is a PUSCH message including a MAC-CE indicating the mismatch.

Aspect 33: The method of Aspect 31, further comprising: initiating a timer based at least in part on transmitting the first message; and storing a codebook associated with the HARQ feedback for a duration of the timer, wherein transmitting the third message is based at least in part on receiving the second message before an expiration of the timer.

Aspect 34: The method of any of Aspects 30-33, wherein the second message indicates a slot index associated with the HARQ feedback.

Aspect 35: The method of any of Aspects 30-34, wherein the second message is a PDSCH message that includes a payload multiplexed with an indication of the additional feedback.

Aspect 36: The method of Aspect 35, further comprising: receiving, from the network node, one or more additional PDSCH messages including an indication of the additional feedback.

Aspect 37: The method of any of Aspects 30-36, wherein the second message comprises ARQ feedback that includes the additional feedback.

Aspect 38: The method of any of Aspects 30-37, wherein the HARQ feedback comprises an ACK or a NACK.

Aspect 39: The method of any of Aspects 30-38, wherein a codebook size associated with the additional feedback is the same as a codebook size associated with the HARQ feedback.

Aspect 40: The method of any of Aspects 30-39, further comprising: refraining from transmitting a message including additional uplink feedback associated with the first message to the network node based at least in part on receiving the second message.

Aspect 41: A method of wireless communication performed by a network node, comprising: receiving, from a user equipment (UE), a first message comprising hybrid automatic repeat request (HARQ) feedback associated with a TB; and transmitting, to the UE, a second message that includes additional feedback associated with the first message.

Aspect 42: The method of Aspect 41, further comprising: decoding the HARQ feedback as an ACK, wherein transmitting the second message is based at least in part on the decoding.

Aspect 43: The method of any of Aspects 41-42, wherein the additional feedback comprises a NACK based at least in part on a decoding operation associated with the HARQ feedback being unsuccessful.

Aspect 44: The method of Aspect 43, further comprising: transmitting, to the UE, a retransmission of the TB based at least in part on the second message including the NACK.

Aspect 45: The method of any of Aspects 41-454, further comprising: receiving, from the UE, a third message based at least in part on a mismatch between the HARQ feedback and the additional feedback; and transmitting, to the UE, a retransmission of the TB based at least in part on the third message.

Aspect 46: The method of Aspect 45, wherein the third message is a PUSCH message including a MAC-CE indicating the mismatch.

Aspect 47: The method of any of Aspects 41-46, further comprising: initiating a timer based at least in part on transmitting the first message, wherein transmitting the second message comprises transmitting the second message before an expiration of the timer.

Aspect 48: The method of any of Aspects 41-47, wherein the second message indicates a slot index associated with the HARQ feedback.

Aspect 49: The method of any of Aspects 47-48, wherein the second message is a PDSCH message that includes a payload multiplexed with an indication of the additional feedback.

Aspect 50: The method of Aspect 19, further comprising: transmitting, to the UE, one or more additional PDSCH messages including an indication of the additional feedback.

Aspect 51: The method of any of Aspects 41-50, wherein the second message comprises ARQ feedback that includes the additional feedback.

Aspect 52: The method of any of Aspects 41-51, wherein the HARQ feedback comprises an ACK or a NACK.

Aspect 53: The method of any of Aspects 41-52, wherein a codebook size associated with the additional feedback is the same as a codebook size associated with the HARQ feedback.

Aspect 54: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-60.

Aspect 55: An apparatus for wireless communication at a device, the apparatus comprising one or more memories and one or more processors coupled to the one or more memories, the one or more processors configured to cause the device to perform the method of one or more of Aspects 1-60

Aspect 56: An apparatus for wireless communication, the apparatus comprising at least one means for performing the method of one or more of Aspects 1-60.

Aspect 57: A non-transitory computer-readable medium storing code for wireless communication, the code comprising instructions executable by one or more processors to perform the method of one or more of Aspects 1-60.

Aspect 58: A non-transitory computer-readable medium storing a set of instructions for wireless communication, the set of instructions comprising one or more instructions that, when executed by one or more processors of a device, cause the device to perform the method of one or more of Aspects 1-60.

Aspect 59: A device for wireless communication, the device comprising a processing system that includes one or more processors and one or more memories coupled with the one or more processors, the processing system configured to cause the device to perform the method of one or more of Aspects 1-60.

Aspect 60: An apparatus for wireless communication at a device, the apparatus comprising one or more memories and one or more processors coupled to the one or more memories, the one or more processors individually or collectively configured to cause the device to perform the method of one or more of Aspects 1-60.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, individually or collectively, configured to cause the UE to:
transmit, to a network node, a first message comprising hybrid automatic repeat request (HARQ) feedback associated with a transport block;
initiate a timer based at least in part on transmitting the first message; and
transmit a second message that includes additional feedback associated with the first message prior to an expiration of the timer.

2. The UE of claim 1, wherein the second message is a physical uplink shared channel (PUSCH) message that includes a payload multiplexed with the additional feedback.

3. The UE of claim 2, wherein the one or more processors are individually or collectively configured to cause the UE to:
transmit, prior to the expiration of the timer, another PUSCH message that includes a payload that is multiplexed with the additional feedback.

4. The UE of claim 2, wherein the one or more processors are individually or collectively configured to cause the UE to:
transmit, to the network node, a scheduling request prior to the expiration of the timer; and
receive, from the network node, an uplink grant based at least in part on the scheduling request, wherein transmitting the PUSCH message is based at least in part on the uplink grant.

5. The UE of claim 1, wherein the one or more processors are individually or collectively configured to cause the UE to:
monitor, during a duration of the timer, for a downlink message including a positive acknowledgment associated with the second message.

6. The UE of claim 5, wherein the one or more processors are individually or collectively configured to cause the UE to:
transmit, after an expiration of the timer, a third message including the additional feedback based at least in part on not receiving the downlink message during the duration of the timer.

7. The UE of claim 1, wherein the one or more processors are individually or collectively configured to cause the UE to:
store, for a duration of the timer, the HARQ feedback based at least in part on initiating the timer; and
receive, during the duration of the timer, a trigger message from the network node, wherein the second message is transmitted based at least in part on receiving the trigger message during the duration of the timer.

8. The UE of claim 1, wherein the second message is transmitted using a connection-less uplink resource.

9. The UE of claim 1, wherein the one or more processors are individually or collectively configured to cause the UE to:
initiate another timer associated with other HARQ feedback associated with another transport block, wherein the second message includes additional feedback associated with the HARQ feedback and the other HARQ feedback based at least in part on the timer overlapping with the other timer.

10. The UE of claim 1, wherein the one or more processors are individually or collectively configured to cause the UE to:
increase a duration of the timer based at least in part on an upcoming scheduling request resource, an upcoming connection-less uplink resource, or both.

11. The UE of claim 1, wherein the one or more processors are individually or collectively configured to cause the UE to:
adjust a duration of the timer based at least in part on a processing timeline associated with an uplink grant for an uplink transmission, generating a scheduling request, generating a connection-less uplink message, or a combination thereof.

12. The UE of claim 1, wherein the second message comprises automatic repeat request (ARQ) feedback that includes the additional feedback.

13. The UE of claim 1, wherein the HARQ feedback comprises a positive acknowledgment (ACK) or a negative acknowledgment (NACK).

14. The UE of claim 1, wherein transmitting the second message is based at least in part on a cyclic redundancy check (CRC) associated with the HARQ feedback having a length that fails to satisfy a threshold.

15. A network node for wireless communication, comprising:
one or more memories; and
one or more processors, coupled to the one or more memories, individually or collectively, configured to cause the network node to:
receive, from a user equipment (UE), a first message comprising hybrid automatic repeat request (HARQ) feedback associated with a transport block;
initiate a timer based at least in part on receiving the first message; and
receive a second message that includes additional feedback associated with the first message prior to an expiration of the timer.

16. The network node of claim 15, wherein the one or more processors are individually or collectively configured to cause the network node to:
transmit, to the UE, an uplink grant for the second message during a duration of the timer, wherein receiving the second message is based at least in part on transmitting the uplink grant.

17. The network node of claim 15, wherein the one or more processors are individually or collectively configured to cause the network node to:
refrain from transmitting a message including additional downlink feedback associated with the first message to the UE based at least in part on receiving the second message.

18. The network node of claim 15, wherein the second message is a physical uplink shared channel (PUSCH) message that includes a payload of the PUSCH message multiplexed with the additional feedback.

19. The network node of claim 18, wherein the one or more processors are individually or collectively configured to cause the network node to:
receive, prior to the expiration of the timer, another PUSCH message that includes a payload multiplexed with the additional feedback.

20. The network node of claim 18, wherein the one or more processors are individually or collectively configured to cause the network node to:
receive, from the UE, a scheduling request prior to the expiration of the timer; and
transmit, to the UE, an uplink grant based at least in part on the scheduling request, wherein receiving the PUSCH message is based at least in part on the uplink grant.

21. The network node of claim 15, wherein the one or more processors are individually or collectively configured to cause the network node to:
receive, after an expiration of the timer, a third message including the additional feedback based at least in part on not transmitting a downlink message to the UE that includes additional downlink feedback associated with the first message.

22. The network node of claim 15, wherein the one or more processors are individually or collectively configured to cause the network node to:
transmit, during a duration of the timer, a trigger message to the UE, wherein the second message is received based at least in part on transmitting the trigger message.

23. The network node of claim 15, wherein the second message is received via a connection-less uplink resource.

24. The network node of claim 15, wherein the one or more processors are individually or collectively configured to cause the network node to:
receive other HARQ feedback associated with another transport block; and
initiate another timer based at least in part on receiving the other HARQ feedback, wherein the second message includes additional feedback associated with the HARQ feedback and the other HARQ feedback based at least in part on the timer overlapping with the other timer.

25. The network node of claim 15, wherein the one or more processors are individually or collectively configured to cause the network node to:
increase a duration of the timer based at least in part on an upcoming scheduling request resource, an upcoming connection-less uplink resource, or both.

26. The network node of claim 15, wherein the one or more processors are individually or collectively configured to cause the network node to:
adjust a duration of the timer based at least in part on a processing timeline associated with an uplink grant for an uplink transmission, generating a scheduling request, generating a connection-less uplink message, or a combination thereof.

27. The network node of claim 15, wherein the second message comprises automatic repeat request (ARQ) feedback that includes the additional feedback.

28. The network node of claim 15, wherein receiving the second message is based at least in part on a cyclic redundancy check (CRC) associated with the HARQ feedback having a length that fails to satisfy a threshold.

29. A method of wireless communication performed by a user equipment (UE), comprising:
transmitting, to a network node, a first message comprising hybrid automatic repeat request (HARQ) feedback associated with a transport block;
initiating a timer based at least in part on transmitting the first message; and
transmitting a second message that includes additional feedback associated with the first message prior to an expiration of the timer.

30. A method of wireless communication performed by a network node, comprising:
receiving, from a user equipment (UE), a first message comprising hybrid automatic repeat request (HARQ) feedback associated with a transport block;
initiating a timer based at least in part on receiving the first message; and
receiving a second message that includes additional feedback associated with the first message prior to an expiration of the timer.
